(19) United States
(12) Patent Application Publication
(10) Pub. No.: US 2015/0253751 A1
(43) Pub. Date: Sep. 10, 2015

(54) Intelligent embedded automatic smoke proof screen control system with remote radio control

(71) Applicant: Tianjin Dakun Electronic Technology Co. Ltd., Tianjin (CN)

(72) Inventor: Li Wang, Tianjin (CN)

(73) Assignee: TIANJIN DUKUN ELECTRONIC TECHNOLOGY CO. LTD., Tianjin (CN)

(21) Appl. No.: 14/201,685

(22) Filed: Mar. 7, 2014

(51) Int. Cl. G05B 15/02

(52) U.S. Cl. CPC G05B 15/02

(57) ABSTRACT

The utility model releases an intelligent automatic smoke proof screen control system with remote radio control, in which the transforming and rectifying circuit is connected to 220V AC power supply and outputs positive and negative 24V voltage to the rectifying circuit to generate 5V DC voltage; the 5V DC voltage is used to respectively power the CPU circuit, remote radio control signal reception circuit, motor driving and control circuit and smoke proof screen lift/drop control circuit; the DC positive and negative 24V voltage is used to power the smoke proof screen lift/drop control circuit; the central processing circuit is connected to the smoke detection signal input interface to receive smoke alarm signals; the central processing circuit delivers control instructions based on the received smoke detection signal and remote radio control signal, and the motor driving circuit receives such control instructions and actuates the smoke proof screen to lift or drop. The control system reduces economic loss, is easy to use and can meet the needs in practical application.

### CROSS-REFERENCE TO RELATED APPLICATION

The application is a continuation of PCT/CN2012/076242 (filed on May 29, 2012), which claims priority of Chinese patent application 201220192742.5 (filed on Apr. 28, 2012), the contents of which are incorporated herein by reference.

### FIELD OF THE INVENTION

This utility model involves smoke proof screens especially an intelligent embedded automatic smoke proof screen control system with remote radio control.

### BACKGROUND OF THE INVENTION

With the fast development of economic society, people are attaching increasingly more attentions to the safety of factories, mines and their residences, so they usually use a smoke proof screen to ensure their personal and property safety.

Existing technologies at least have the following disadvantages and defects:

With existing technologies, the smoke proof screen should be controlled manually, which makes it not very easy to use, what's more, during nights when such smoke proof screen is not attended, if fire occurs, it may lead to further economic loss, therefore, they can not meet the practical needs.

### SUMMARY OF THE INVENTION

This utility model provides an intelligent automatic smoke proof screen control system with remote radio control which is easy to use and helps to reduce potential economic loss and can meet the practical needs and is described in details as follows:

An intelligent automatic smoke proof screen control system with remote radio control includes: a transforming and rectifying circuit which is connected to 220V AC power supply and outputs positive and negative 24V voltage to the rectifying circuit, the said rectifying circuit outputs 5V DC voltage; the said 5V DC voltage is used to respectively power the CPU circuit, remote radio control signal reception circuit, motor driving and control circuit and smoke proof screen lift/drop control circuit; the said DC positive and negative 24V voltage is used to power the said smoke proof screen lift/drop control circuit; the said central processing circuit is connected to the said smoke detection signal input interface to receive smoke alarm signals; the said central processing circuit delivers control instructions based on the said smoke detection signal and the said remote radio control signal, and the said motor driving circuit receives such control instructions and actuates the said smoke proof screen to lift or drop.

The said rectifying circuit includes: the primary interface, in which the said primary interface is powered by the said +/−24V DC power supply, and the said primary interface is respectively connected to the positive electrode of the primary filter capacitor and an end of the primary resistor and the negative electrode of the said filter capacitor is grounded; the other end of the said primary resistor is connected to the input end of stabilivolt and the output end of such said stabilivolt outputs the said 5V DC power which is respectively connected to the positive electrode of the secondary filter capacitor and the anode of light emitting diode (LED) and the negative electrode of the said secondary filter capacitor and the cathode of the said LED are grounded.

The said central processing circuit includes: Single Chip Microcomputers (SCM), SMK/S1 to SMK/S12 which are the input ends of smoke alarm signals and are connected to the said smoke detection signal input interface; CTR/S1 to CTR/S12 which are the instruction output ends and are connected to the said motor driving and control circuit; RADIO/R and RADIO/CTR which are input ends of remote radio control signals and are connected to the said remote radio control signal reception circuit; MOT/DOWN and MOT/UP which are respective control signals for lifting and dropping the smoke proof screen and are connected to the said smoke proof screen lift/drop control circuit; CRT1 and CRT2 which are input pins of control signals of the limit switch in such said smoke proof screen lift/drop control circuit.

The said remote radio control signal reception circuit includes: a reception resonance circuit which inputs the said reception signals into a demodulation module and the said demodulation module demodulates such reception signals into digital signals and outputs such digital signals to the said central processing circuit.

The said reception resonance circuit includes: antennae which is connected respectively to an end of the primary inductor, an end of the primary capacitor and an end of the secondary capacitor and the other end of the said primary capacitor is connected respectively to the reception end of the said demodulation module and an end of the secondary inductor, while the other end of the said secondary inductor, the other end of the said secondary capacitor and the other end of the said primary inductor are grounded.

The said smoke detection signal input interface includes: the secondary interface of 16# pin, 5#˜16# pins which are connected to the said central processing circuit, 4# pin which is grounded, and 1#˜3# pins which are vacant.

The said motor driving and control circuit includes: 12 motor driving and control units which respectively includes: triodes, of which the emitter is connected to the said 5V DC power and the base is connected to the said central processing circuit; the collector of such said triodes is connected to a relay and the output end of such said relay is connected to the lift/drop control circuit of the said smoke proof screen.

The said smoke proof screen lift/drop control circuit includes: smoke proof screen lifting unit and dropping control unit.

The said smoke proof screen lifting unit includes: the thirteenth triode, of which the emitter is connected to the said 5V DC power and the base is connected to the said central processing circuit and the collector is connected to the thirteenth relay and the said thirteenth relay is respectively connected to the said DC +24V power and the said motor driving and control circuit;

The said smoke proof screen dropping unit includes: the fourteenth triode, of which the emitter is connected to the said 5V DC power and the base is connected to the said central processing circuit and the collector is connected to the fourteenth relay and the said fourteenth relay is respectively connected to the said DC −24V power and the said motor driving and control circuit;

This utility model can realize the following benefits: when the smoke detection signal input interface receives smoke signals, the central processing circuit outputs control instructions to the motor driving and control circuit and after the latter receives such control instructions, it will actuate the smoke proof screen lift/drop control circuit. With this system, it can realize remote control on the smoke proof screen, so it is easy to use, helps to reduce economic loss and can meet the practical needs.

### BRIEF DESCRIPTION OF THE DRAWINGS

FIG. 1 shows the structure diagram of an intelligent embedded automatic smoke proof screen control system with remote radio control provided by this utility model;

FIG. 2 shows the schematic diagram of the rectifying circuit provided by this utility model;

FIG. 3 shows the schematic diagram of the central processing circuit provided by this utility model;

FIG. 4 shows the schematic diagram of the remote radio control signal reception circuit provided by this utility model;

FIG. 5 shows the schematic diagram of the smoke detection signal input interface provided by this utility model;

FIG. 6a shows the primary schematic diagram of motor driving and control circuit provided by this utility model;

FIG. 6b shows the secondary schematic diagram of motor driving and control circuit provided by this utility model;

FIG. 7 shows the schematic diagram of the smoke proof screen lift/drop control circuit provided by this utility model;

The numbers shown on such drawings represents the following parts:

| | |
|---|---|
| J4: Primary interface; | C11: Primary filter capacitor; |
| C12: Secondary filter capacitor; | R4: Primary resistor; |
| U1: Stabilivolt; | LED: Light emitting diode |
| U2: Demodulation module; | ANT1: Antenna |
| L1: Primary inductor; | L2: Secondary inductor; |
| C7: Primary capacitor; | C8: Secondary capacitor; |
| Q1~Q12: The 1st to 12th triodes; | Q13: the 13th triode; |
| Q14: the 14th triode; | JDQ1~JDQ12: the 1st to 12th relays; |
| JDQ13; the 13th relay; | JDQ14: the 14th relay; |

MK/S1~SMK/S12: Smoke alarm signal input interface;
CTR/S1~CTR/S12: Instruction output interface;
RADIO/R and RADIO/CTR: Remote radio control reception signal input
interface;
MOT/DOWN: Smoke proof screen dropping control signal;
MOT/UP: Smoke proof screen lifting control signal;
CRT1 and CRT2: Limit switch control signal input pin.

### DETAILED DESCRIPTION OF THE INVENTION

The embodiment of this utility model is further illustrated in details with help of drawings, in order to clarify the purpose, technical solution and advantages of this utility model.

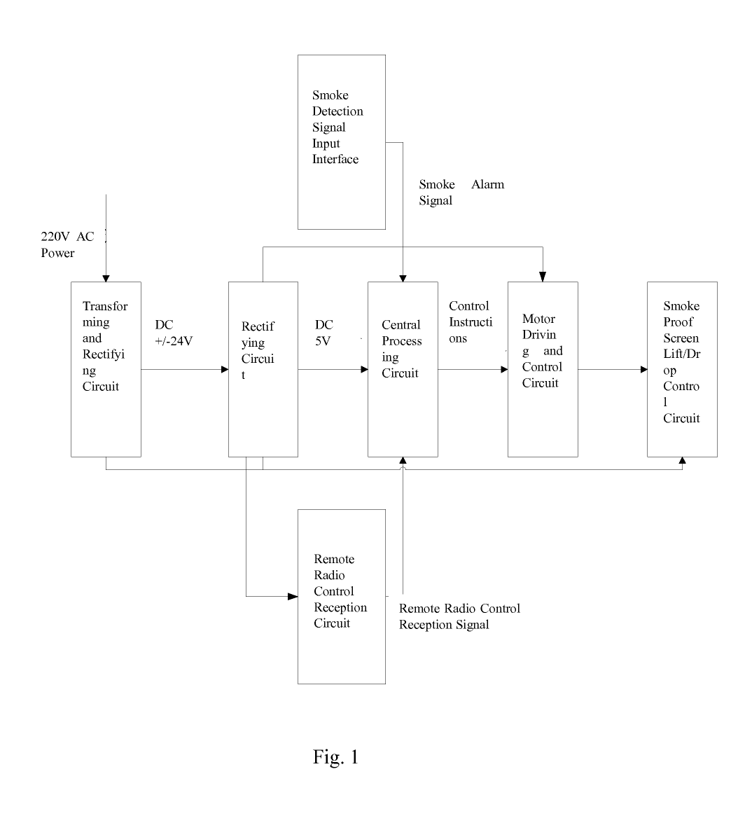

In order to reduce economic loss and to make the application easier, as shown in FIG. 1, this utility model provides an intelligent embedded automatic smoke proof screen control system with remote radio control, which is described as follows:

An intelligent automatic smoke proof screen control system with remote radio control includes a transforming and rectifying circuit which is connected to 220V AC power supply and outputs positive and negative 24V voltage to the rectifying circuit which generates 5V DC voltage; the 5V DC voltage is used to respectively power the CPU circuit, remote radio control signal reception circuit, motor driving and control circuit and smoke proof screen lift/drop control circuit; the DC positive and negative 24V voltage is used to power the smoke proof screen lift/drop control circuit; the central processing circuit is connected to the smoke detection signal input interface to receive smoke alarm signals; the central processing circuit delivers control instructions based on the received smoke detection signal and remote radio control signal, and the motor driving circuit receives such control instructions and actuates the smoke proof screen to lift or drop.

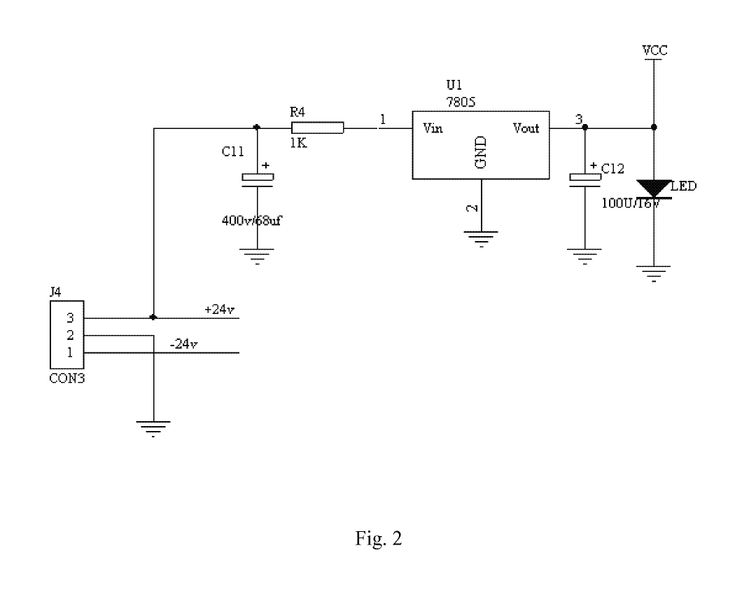

In this system, as shown in FIG. 2, the rectifying circuit includes: the primary interface J4, which is powered by the +/−24V DC power supply and is respectively connected to the positive electrode of the primary filter capacitor C11 and an end of the primary resistor R4 while the negative electrode of the primary filter capacitor C11 is grounded; the other end of the primary resistor R4 is connected to the input end of stabilivolt U1 and the output end of such stabilivolt U1 outputs 5V DC power which is respectively connected to the positive electrode of the secondary filter capacitor C12 and the anode of light emitting diode (LED) and the negative electrode of secondary filter capacitor C12 and the cathode of the LED are grounded.

In this system, in order to embody the utility model, primary interface J4 at least includes three pins, of which one pin is connected to DC +24V power, another is connected to DC −24V power and other pins are grounded. In the embodiment example of this utility model, it illustrates the system with three pins, while such limit does not exist with the real embodiment.

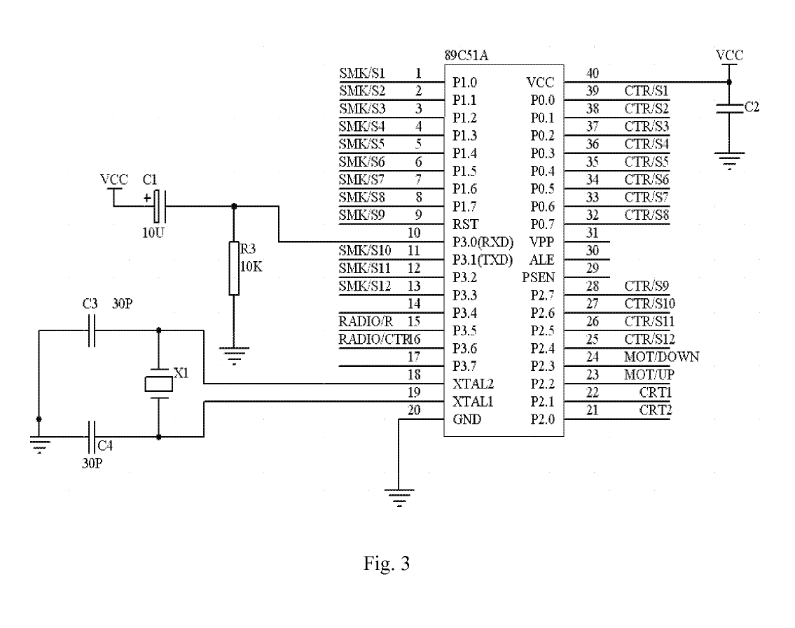

In this system, as shown in FIG. 3, the central processing circuit includes: Single Chip Microcomputers (SCM), SMK/S1 to SMK/S12 which are the input ends of smoke alarm signals and are connected to the smoke detection signal input interface; CTR/S1 to CTR/S12 which are the instruction output ends and are connected to the motor driving and control circuit; RADIO/R and RADIO/CTR which are input ends of remote radio control signals and are connected to the remote radio control signal reception circuit; MOT/DOWN and MOT/UP which are respective control signals for lifting and dropping the smoke proof screen and are connected to the smoke proof screen lift/drop control circuit; CRT1 and CRT2 which are input pins of control signals of the limit switch in such smoke proof screen lift/drop control circuit.

In this system, 89C51A SCM is taken as an example in the illustration of the embodiment of the utility model. The 10# pin and 40# pin of the SCM are connected to the DC 5V power, and pins 14#, 17#, 31#, 30# and 29# are vacant; 18# pin and 19# pin are connected to crystal oscillator X1; 20# pin is grounded.

That is to say, when the smoke detection signal interface detects smoke, it sends the smoke alarm signal to the SCM via the corresponding pins from SMK/S1 to SMK/S12, and the SCM determines the region of smoke on basis of the pins, via which the smoke alarm signals are input, and then the signals are processed. Through controlling the pins of instruction output ends from CTR/S1 to CTR/512, the system can control the motor driving and control circuit is relevant regions to isolate the smoke while the SCM controls the smoke proof screen to lift or to drop by means of control signals of limit switch.

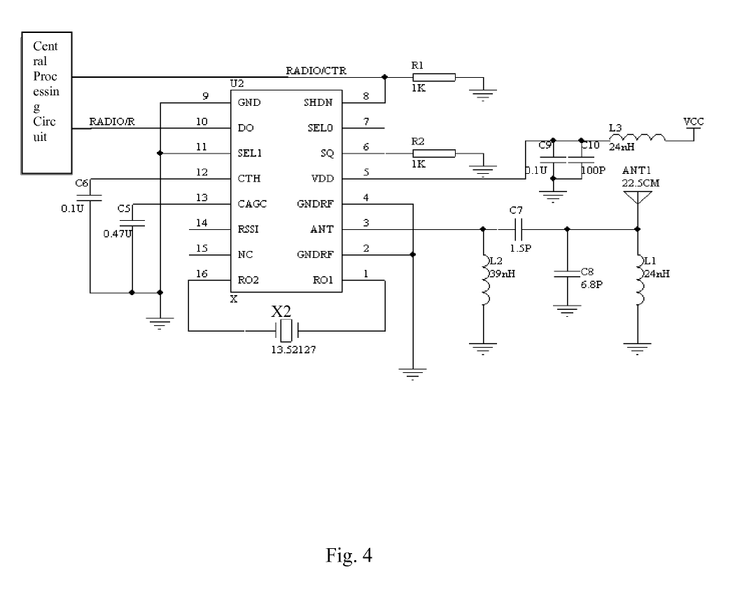

In this system, as shown in FIG. 4, the remote radio control signal reception circuit includes: reception resonance circuit which inputs the signals received to the demodulation module U12, where such signals are demodulated into digital signals and are output, via the remote radio control signal input interfaces RADIO/R and RADIO/CTR, to the central processing circuit. The 7# pin in demodulation module U2 is vacant.

In this system, the reception resonance circuit includes: antenna ANT1 which is connected respectively to an end of the primary inductor L1, an end of the primary capacitor C7 and an end of the secondary capacitor C8, and the other end of the primary capacitor C7 is connected respectively to the reception end ANT of the demodulation module U12 and an end of the secondary inductor L2, while the other end of the secondary inductor L2, the other end of the secondary capacitor C8 and the other end of the primary inductor L1 are grounded.

When antenna ANT1 is 22.5 CM long, the inductance of primary inductor L1 is 24 nH, and the inductance of secondary inductor L2 is 39 nH; when the capacitance of primary capacitor C7 is 1.5 PF and the capacitance of secondary capacitor C8 is 6.8 PF, the resonant frequency is 433 MHZ; when demodulation module U2 is MICRF113, the receiving sensitivity can reach 110 dB, so that it works well to receive the remote signals and the working distance may be up to 200 meters, so that good remote control can be realized. The remote control helps to isolate smoke and to effectively ensure personal and property safety.

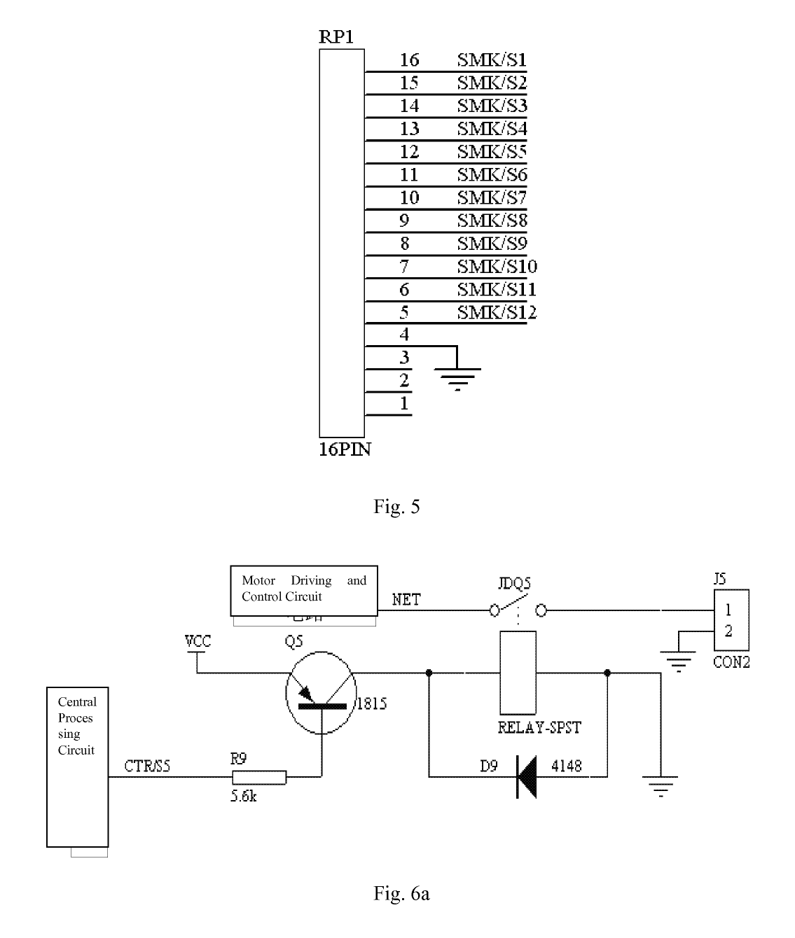

In this system, as shown in FIG. 5, the smoke detection signal input interface includes: the secondary interface RP1 of 16# pin, 5#˜16# pins which are connected to the central processing circuit, 4# pin which is grounded, and 1#˜3# pins which are vacant.

That is to say, the smoke detection signals are input into the central processing circuit via the smoke detection signal input interface, and the central processing circuit processes such signals on basis of their source.

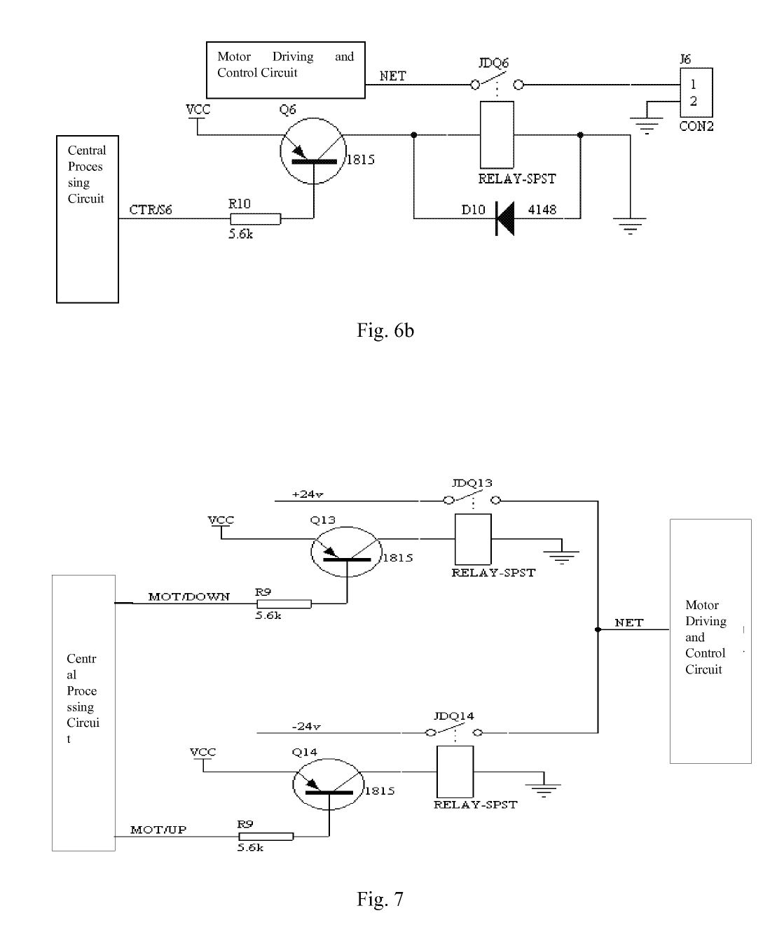

In this system, as shown in FIGS. 6a and 6b, the motor driving and control circuit includes: 12 motor driving and control units which respectively includes: triodes, of which the emitter is connected to the 5V DC power and the base is connected to the central processing circuit; the collector of such triodes is connected to a relay and the output end NET of such relay is connected to the lift/drop control circuit of the smoke proof screen.

That is to say, the motor driving and control circuit includes triodes Q1˜Q12, relays JDQ1˜JDQ12 and 12 output ends NET.

When smoke alarm is detected in a region, the central processing circuit will deliver instructions to actuate the corresponding motor driving and control unit, which means with such instructions, the triode is put through and controls the functioning of corresponding relay and the corresponding driving and control unit is powered.

In this system, as shown in FIG. 7, the smoke proof screen lift/drop control circuit includes: smoke proof screen lifting unit and dropping control unit.

The smoke proof screen lifting unit includes: the thirteenth triode Q13, of which the emitter is connected to the 5V DC power and the base is connected to the central processing circuit and the collector is connected to the thirteenth relay JDQ13 and the thirteenth relay JDQ13 is respectively connected to the DC +24V power and the motor driving and control circuit;

The smoke proof screen dropping unit includes: the fourteenth triode Q14, of which the emitter is connected to the 5V DC power and the base is connected to the central processing circuit and the collector is connected to the fourteenth relay JDQ14 and the fourteenth relay JDQ14 is respectively connected to the DC −24V power and the motor driving and control circuit;

That is to say, the central processing circuit delivers instructions to the smoke proof screen lifting unit or the dropping unit on basis of control instructions received: when it is needed to drop the smoke proof screen, the central processing circuit will deliver instructions to the thirteenth triode Q13 to put it through, so that the DC +24V power is put through and the motor driving and control circuit will drop the smoke proof screen, which will be stopped by the limit switch on the spindle of such smoke proof screen; similarly when it is needed to lift the smoke proof screen, the central processing circuit delivers instructions to the fourteenth triode to put it through, so that DC −24V power is put through and the motor driving and control circuit will lift the smoke proof screen, which will be stopped by the limit switch on the external cover of such smoke proof screen

In this system, the embodiment example of this utility model does not have any restrictions on the models of above-mentioned components and in the real embodiment, the utility model will not have any restrictions either.

In all, this utility model embodiment example provides an intelligent embedded automatic smoke proof screen control system with remote radio control. When the smoke detection signal input interface receives smoke signals, the central processing circuit outputs control instructions to the motor driving and control circuit and after the latter receives such control instructions, it will actuate the smoke proof screen lift/drop control circuit. With this system, it can realize remote control on the smoke proof screen, so it is easy to use, helps to reduce economic loss and can meet the practical needs.

Technical persons in this area can understand that the drawing attached works only as a preferred embodiment example and the numbers in the above utility model embodiment example are only for description purpose and do not stand for the advantages or disadvantages of the embodiment example.

The description above is only a relatively favorable embodiment example of this utility model and constitutes no limitation on such utility model. All modifications, equivalent substitution and improvements under the guideline and principles of this utility model are covered in the protection range of this utility model.

1. An intelligent automatic smoke proof screen control system with remote radio control, including a transforming and rectifying circuit which is characterized by that the said transforming and rectifying circuit is connected to 220V AC power supply and outputs positive and negative 24V voltage to the rectifying circuit, the said rectifying circuit outputs 5V DC voltage; the said 5V DC voltage is used to respectively power the CPU circuit, remote radio control signal reception circuit, motor driving and control circuit and smoke proof screen lift/drop control circuit; the said DC positive and negative 24V voltage is used to power the said smoke proof screen lift/drop control circuit; the said central processing circuit is connected to the said smoke detection signal input interface to receive smoke alarm signals; the said central processing circuit delivers control instructions based on the said smoke detection signal and the said remote radio control signal, and the said motor driving circuit receives such control instructions and actuates the said smoke proof screen to lift or drop.

2. According to claim 1 above, an intelligent embedded automatic smoke proof screen control system with remote radio control, which is characterized by that the said rectifying circuit includes: the primary interface, in which the said primary interface is powered by the said +/−24V DC power supply, and the said primary interface is respectively connected to the positive electrode of the primary filter capacitor and an end of the primary resistor and the negative electrode of the said filter capacitor is grounded; the other end of the said primary resistor is connected to the input end of stabilivolt and the output end of such said stabilivolt outputs the said 5V DC power which is respectively connected to the positive electrode of the secondary filter capacitor and the anode of light emitting diode (LED) and the negative electrode of the said secondary filter capacitor and the cathode of the said LED are grounded.

3. According to claim 1 above, an intelligent embedded automatic smoke proof screen control system with remote radio control, which is characterized by that the said central processing circuit includes: Single Chip Microcomputers (SCM), SMK/S1 to SMK/S12 which are the input ends of smoke alarm signals and are connected to the said smoke detection signal input interface; CTR/S1 to CTR/S12 which are the instruction output ends and are connected to the said motor driving and control circuit; RADIO/R and RADIO/CTR which are input ends of remote radio control signals and are connected to the said remote radio control signal reception circuit; MOT/DOWN and MOT/UP which are respective control signals for lifting and dropping the smoke proof screen and are connected to the said smoke proof screen lift/drop control circuit; CRT1 and CRT2 which are input pins of control signals of the limit switch in such said smoke proof screen lift/drop control circuit.

4. According to claim 1 or 3 above, an intelligent embedded automatic smoke proof screen control system with remote radio control, which is characterized by that the said remote radio control signal reception circuit includes: a reception resonance circuit which inputs the said reception signals into a demodulation module and the said demodulation module demodulates such reception signals into digital signals and outputs such digital signals to the said central processing circuit.

5. According to claim 4 above, an intelligent embedded automatic smoke proof screen control system with remote radio control, which is characterized by that the said reception resonance circuit includes: antennae which is connected respectively to an end of the primary inductor, an end of the primary capacitor and an end of the secondary capacitor and the other end of the said primary capacitor is connected respectively to the reception end of the said demodulation module and an end of the secondary inductor, while the other end of the said secondary inductor, the other end of the said secondary capacitor and the other end of the said primary inductor are grounded.

6. According to claim 1 above, an intelligent embedded automatic smoke proof screen control system with remote radio control, which is characterized by that the said smoke detection signal input interface is described specifically as: the second interface of 16# pin and 5#˜16# pins are connected to the said central processing circuit, the 4# pin is grounded and 1#˜3# pins are vacant.

7. According to claim 1 above, an intelligent embedded automatic smoke proof screen control system with remote radio control, which is characterized by that the motor driving and control circuit includes: 12 motor driving and control units which respectively includes: triodes, of which the emitter is connected to the said 5V DC power and the base is connected to the said central processing circuit; the collector of such said triodes is connected to a relay and the output end of such said relay is connected to the lift/drop control circuit of the said smoke proof screen.

8. According to claim 1 above, an intelligent embedded automatic smoke proof screen control system with remote radio control, which is characterized by that the said smoke proof screen lift/drop control circuit includes: smoke proof screen lifting control unit and smoke proof screen dropping control unit.
The said smoke proof screen lifting unit includes: the thirteenth triode, of which the emitter is connected to the said 5V DC power and the base is connected to the said central processing circuit and the collector is connected to the thirteenth relay and the said thirteenth relay is respectively connected to the said DC +24V power and the said motor driving and control circuit;
The said smoke proof screen dropping unit includes: the fourteenth triode, of which the emitter is connected to the said 5V DC power and the base is connected to the said central processing circuit and the collector is connected to the fourteenth relay and the said fourteenth relay is respectively connected to the said DC −24V power and the said motor driving and control circuit;
